(19) United States
(12) Patent Application Publication
(10) Pub. No.: US 2005/0024892 A1
(43) Pub. Date: Feb. 3, 2005

(54) Installation for artificial rainbow generation and observation of same

(76) Inventor: Miguel Cabrera, Vigo (ES)

Correspondence Address: ANTHONY H. HANDAL;KIRKPATRICK & LOCKHART, LLP, 599 LEXINGTON AVENUE, 31ST FLOOR, NEW YORK, NY, 10022-6030, US

(21) Appl. No.: 10/496,413

(22) PCT Filed: Nov. 21, 2002
(86) PCT No.: PCT/ES02/00548

(30) Foreign Application Priority Data
Nov. 21, 2001 (ES) P 200102573

(51) Int. Cl. F21S 4/00

(52) U.S. Cl. 362/565

(57) ABSTRACT

The installation is constituted by means of the functional combination of a water curtain generator or orientable arc-generator and of an observation platform, said water curtain generator (4) having a structure that is based on a plurality of uniformly distributed sprayers with an ascending water projection, consequently obtaining a homogeneous water curtain; the observation platform consists of a circular pool (3) with an observation-ascension ramp (1) that surrounds it, the height that this ramp must reach at each point, shall depend on the geographic latitude; the observer shall be situated backwards to the Sun on the observation platform, the arc-generator perpendicular to the rays of the Sun at a set distance facing the observer, with which the primary rainbow (5) generated by the incidence of the Solar rays on the water drops, will be visualised.

### OBJECT OF THE INVENTION

The present invention refers to a installation for the generation of a rainbow using sunlight and that makes possible its observation from any place and at any hour.

The installation has been specially conceived to be installed in urban areas such as town squares, roundabouts, fountains, gardens, etc. and is in principle, designed for circular zones where a rainbow, with similar radius to the radius of the zone in which it is installed, can be observed.

### BACKGROUND OF THE INVENTION

The rainbow is produced by the total combined refraction, dispersion and reflection effects of sun-light on drops of water.

When the observation conditions are favourable, two arcs can be seen: the interior, brighter arc, called primary arc, and the weaker interior arc. The colours of the primary arc are from outside inwards, red, orange-green, yellow, green, blue, indigo and violet, whilst in the exterior arc, the colours are inverted.

The phenomenon that occurs in each one of the drops produced by the primary arc is as follows: the solar ray that falls on a drop of water is refracted on the first surface and in part reflected on the second, being once again refracted by the previous surface when it exits from the drop. In the case of another ray, two refractions and two reflections are produced, with which the resultant ray has a greater loss, producing a less luminous arc, that is to say, the secondary arc.

If a ray with any given colour falls on a point on the surface of the drop in such a way that its deviation is maximum, all the rest of the rays with the same colour that fall on the drop surface immediately adjacent to this point will be reflected according to a direction adjacent to the first, due to which, each colour is strongly reflected in the direction of the maximum deviation corresponding to that particular colour. In the primary arc, the maximum deviation angle of the red light is of approximately 42°, the angle corresponding to the violet light is approximately 40°, and for the other colours it is to be found between the previously indicated values.

Up to now, the visualisation of the rainbow has only been feasible under specific natural, meteorological conditions and when the observer is in an appropriate location.

### DESCRIPTION OF THE INVENTION

The installation proposed by the invention makes possible the observation of the rainbow in any place and at any moment, using sun-light for its. creation, the phenomenon being observed with greater sharpness of image on sunny days, but allowing this visualisation in partially cloudy days and even, due to the effect of moonlight, during luminous nights.

For this, and more specifically, the installation consists of a curtain of water drops or of a curtain of moisturised air or a mixture of both, with drop geometry, dimensions, positions and characteristics appropriate for the production of the intended phenomenon in the drops of this curtain, due to the same causes that produce the natural phenomenon.

The drop size with which the rainbow can be observed is comprised within a very wide range, and can oscillate between drops with the size of average rain up to being capable of observation in “drops” contained by very moisturised air, near saturation: therefore, we can create curtains with water drops that are relatively large, curtains with saturated moisturised air or curtains that are a mixture of small size drops with saturated moisturised air. The quality of the curtain in each case can be different and shall depend on other factors (cost, wind conditions, aesthetic factors, etc.) for the selection of one or other size of drop to form the curtain.

This curtain shall be generated by an apparatus or system capable of producing at each moment, a curtain with the previously indicated characteristics; we shall call this apparatus or system, arc-generator.

This curtain-producing apparatus is complemented with an observation platform on which the observer is situated in order to be able to keep at all moments the relative appropriate positions between the observer and the curtain with the Sun in any position.

To achieve this, the observer shall be situated on the observation platform, always with his back to the Sun and looking towards the curtain, this curtain being totally or partially situated in the space comprised between two imaginary revolution cones which have their vertex on the observer and having a common axis parallel to the Sun rays at all moments, the generatrix of these two cones being approximately at respective angles of 40° and 42°; consequently, the drops on which the 7 colours of the rainbow are produced are the ones which are comprised between these two cones (see FIG. 1); therefore, the curtain shall be situated in such a way that it has a maximum number of drops in this zone. The observer-curtain backwall distance where the rainbow is observed shall determine the radius of the observed rainbow.

A good production shall be obtained by using preferably curtains with water drops made up of drops with reduced volume, uniformly distributed throughout the curtain and with a high concentration of drops; obtaining in turn, a good production by using a mixture of water drops with reduced volume together with saturated moisturised air.

The primary rainbow is produced as has been previously described between the 40° and 42° angles (approximately), with that same procedure, the secondary rainbow shall be produced between the 50° and 54° angles (approximately), which shall always have, under equal conditions, less density. With the intention of maximising the spectacularity and sharpness of image of the phenomenon designs are going to be mainly created in order to observe the primary rainbow, though on occasions and from various positions, both rainbows shall be observed.

The observation platform shall allow the observer to be situated at a minimum necessary distance at all moments, as regards the curtain, this minimum distance shall depend on the angle of the Sun on the horizontal and on the dimensions of the rainbow that is wished to be observed.

By varying the absolute positions of the observer and/or of the curtain, but without modifying the previously described relative positions, a great diversity of observation platform and arc-generator designs may be obtained that shall produce the desired effect and that may be adapted to diverse installation zones.

We are mainly going to develop an installation to be installed in circular zones.

A rainbow with similar radius to the zone in which it is installed shall be observed at all moments in a circular zone. We shall place the observer on an observation platform situated on the perimeter of the circular zone; the platform shall have a sufficient minimum height to enable the observation of the rainbow with the desired dimensions at all moments; the observer is situated with his back to the Sun, looking towards the curtain of water drops or moisturized air; the curtain shall be inside the perimeter of the installation; the dimensions and position of the curtain shall be determined by the angle of the Sun at each moment and the dimensions of the rainbow to be observed; the geometry of the curtain may adopt diverse shapes with which similar results can be obtained.

More particularly, if 180° of the top part of a rainbow with similar radius to that of the installation of a circular installation is wished to be observed, the height of the observation platform shall be sufficient at all points to enable the appreciation of an arc with these dimensions and the arc-generator shall create a curtain that shall be placed at all moments keeping a maximum number of drops on the appropriate observation cones for the optimum position of the observer (on the observation platform, as close as possible to the Sun) at all moments, and of a curtain width and sufficient drop characteristics to produce the phenomenon with a sharp definition.

The rainbow can likewise be observed in the hours near dawn and sunset, from outside the installation. The installation may also serve as sun-dial and calendar.

### DESCRIPTION OF THE DRAWINGS

Additionally to the description that is being made and with the purpose of aiding to a better understanding of the characteristics of the invention according to a preferred example of the practical embodiment of the same, a set of drawings in which, with illustrative and non-limitative character the following has been represented, is enclosed to this description, forming integral part of the same.

FIG. 1 shows a perspective view of an observation platform (1) that enables an observer to be situated at all moments at a determined distance as regards a curtain of water drops or as regards a curtain of moisturised air (C) the minimum necessary distance shall depend on the angle at which the Sun is situated on the horizontal and on the radius and size of the rainbow (5) that is wished to be observed, the observer situated on the platform has his back to the Sun and looking towards the curtain of water drops and moisturised air; the curtain is totally or partially situated in the space comprised between two imaginary revolution cones that have their vertex at the observer and with a common axis, and parallel to the Sun rays (OP straight line) at all moments, the genetrix of the cones are approximately at angles of 40° and 42° respectively.

In the example, height H where the observer is, shall be determined by the angle of the Sun at that moment (S°), the radius (r)of the observed rainbow and its arc (approximately 270° of the rainbow is seen).

The distance from the observer to the curtain backwall where the rainbow is observed shall depend on the radius of the rainbow that is wished to be observed.

FIG. 2 shows a perspective view of the installation situated in the Northern Hemisphere in middle latitudes, and is provided with an ascension observation ramp (1) observation zone (2), at floor level below 1, pool (3) excavated in the ground. In the centre is the arc-generator (4) that produces a rainbow (5), the mechanical arm (6) shall place the arc-generator at each moment in the appropriate position, in order to maintain the relative positions between the arc-generator and the observer for any position of the Sun.

The observer shall be situated at point O and perpendicular to the base of the point P arc-generator, angle POA shall be 42° 2′, angle POB shall be 40° as indicated in the drawing. The Sun, point O and point P shall be at one same perpendicular plane to the horizontal, OA and OB shall rotate forming two observation cones where the rainbow shall be formed. The straight line OP is always parallel to the rays of the Sun.

FIG. 3 shows a perspective view of the installation situated in the Northern Hemisphere in high latitudes, of the same type as that of FIG. 2, but in this case, the pool excavated in the ground is not necessary since it is a high latitude and the Sun will reach a small angle on the horizontal.

FIG. 4 shows a perspective view of the installation situated in the Northern Hemisphere in tropical latitudes, the Sun, depending on the station of the year shall illuminate from the North and from the South, due to which, the maximum necessary elevation on all the platform is required. An elevated ring shall be used at that maximum necessary height and an ascension observation platform will additionally serve to situate the observer when the Sun is at intermediate angles.

The Figure shows the position at which the rainbow shall be seen at the moment when the rays of the Sun are almost perpendicular to the horizontal

FIG. 5 shows a perspective view of a platform, dimensioned for latitudes between 35° and 40° North. This example has a pool radius 10 m. The maximum height reached by the platform is of 3.5 m and the pool depth is of 2.6 m, the radius of the observable rainbow is around 8 m.

The ascending platform has a width of 1.5 m and presents a double 14% slope during the first 120° ascension, and 5% of the other 60°. There shall be a handrail along all the platform as is partially seen in the drawing.

A windshield (V) is included, intended to that purpose.

FIG. 6 shows a schematic representation of the hydraulic circuit components formed by the arc-generator.

FIG. 7 shows a simplified, schematic representation of the hydraulic circuit components, that only consists of a semicircular branch in order to cut costs using small sized kits.

FIG. 8 shows the mechanical arm (schematically represented) that places the arc-generator in the appropriate position at each moment, In order to achieve this, it shall be provided with three turns and one displacement

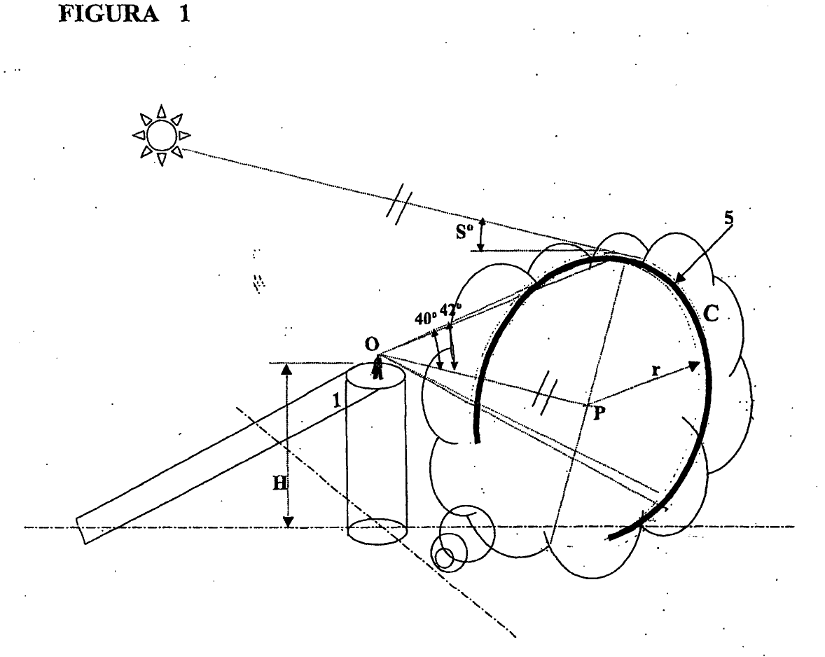

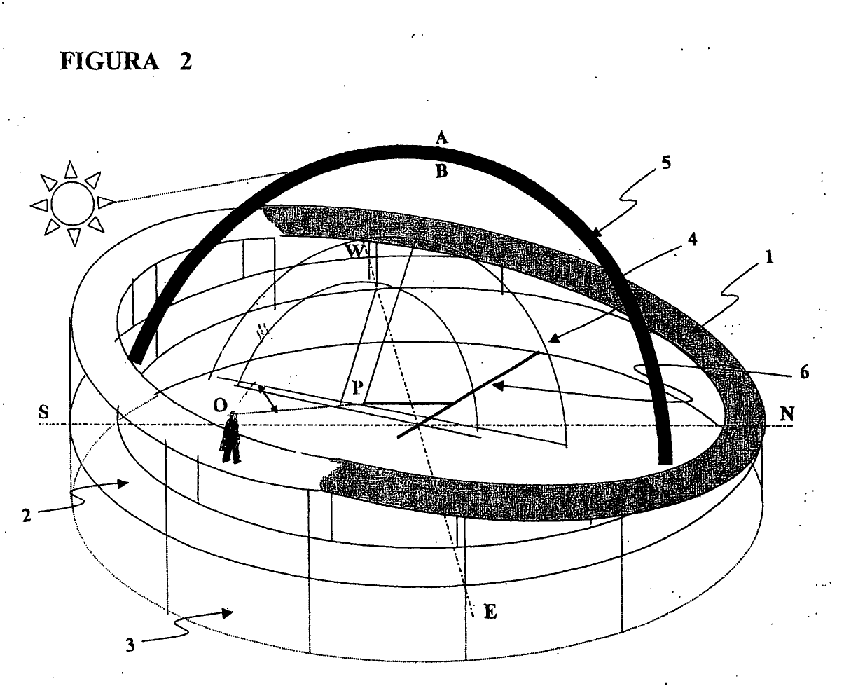

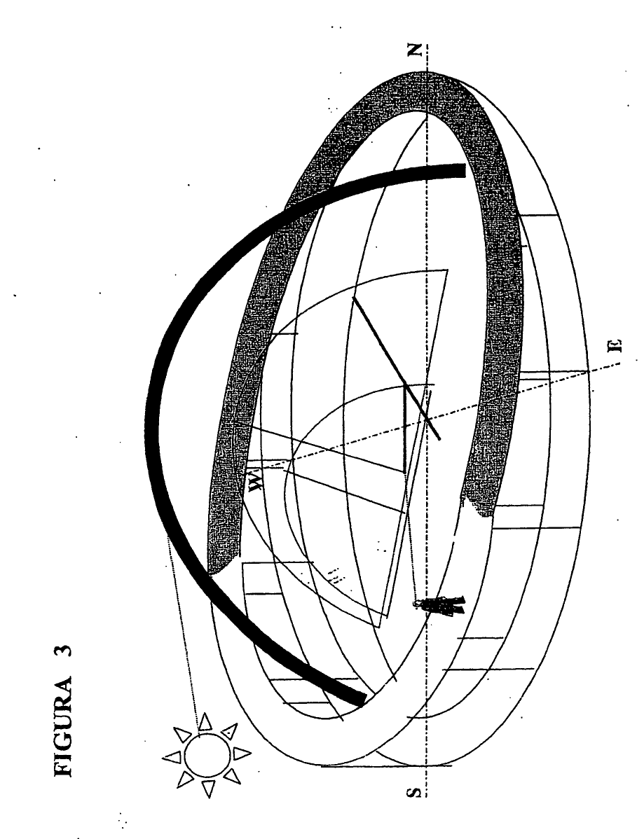

It performs a turn G1, pivoting on A due to which, wheel B moves on rails (16) placed at the bottom of the installation pool. By means of this turn, the mechanical arm is consequently placed facing the Sun.

The necessary height and position is obtained with displacement D1, (point C is going to be displaced in direction AB) and turn G2 around C, using a counterweight (17) to aid the motor in this turn. With turn G3, the metallic structure is placed where the arc-generator (19) is assembled, perpendicular to the Sun rays.

The metal rod (18) that goes from C to D shall be rigid and shall have a length comprised between 0.8 r and r depending on each installation (r being the radius of the installation pool).

FIG. 9 shows the vertical and horizontal projection of the geometry of the jet selected, generated by a spraying nozzle when the spray out-put mouth is pointing in vertical, upward direction.

FIG. 10 shows the vertical and horizontal projection of the sprayers (15) of the upper arc-generator branch which is vertically orientated. The zone that is to be found between the circumferences of points S1 and S2 shall be optimum observation zones, the distances between the different branches must be such, that they cover, as optimum observation zone, all the arc-generator surface. The optimum observation zone of the bottom branch-line, having in consequence to couple with the top observation branch-line.

In order to meet these conditions, the installation must be precisely adjusted. When a installation is assembled, the chokes shall be manually adjusted together with the adjustment of each nozzle's out-put mouth angle in order to provide the greatest possible uniformity and to minimize splashing. The use of coloured water may be useful in order to carry out the adjustments and to observe the uniformity of the curtain with greater clarity.

The adjustment shall be carried out with the arc-generator placed perpendicular to the floor, setting the pressure by means of the chokes and adjusting the out-put angles of the sprayers, subsequently checking the behaviour at 45° and at 0°, to perform, if necessary, the final readjustments.

FIG. 11 shows the vertical and horizontal projection of the upper branch sprayers of an arc-generator that are in vertical position.

In this case, the spraying mouths have been placed in circular upward direction in order to minimize the spraying outside the installation.

FIG. 12 shows the horizontal, vertical and lateral projection of an arc-generator.

In this case, it consists of 4 branch lines C3 and C4 that form one first curtain (C) on the front part that overlaps with the one formed by C1 and C2 on the rear part in order to obtain a curtain of greater width (around 40-50% of the OP distance).

The generated curtain's shape shall be almost semi frusto-conical, the observer is at O, his visual cone at Cv that shall intersect with the frusto-conical curtain of water, thus forming the rainbow at the backwall of the curtain at A. P shall be the centre of the generated rainbow, angle POA shall be 42.2°.

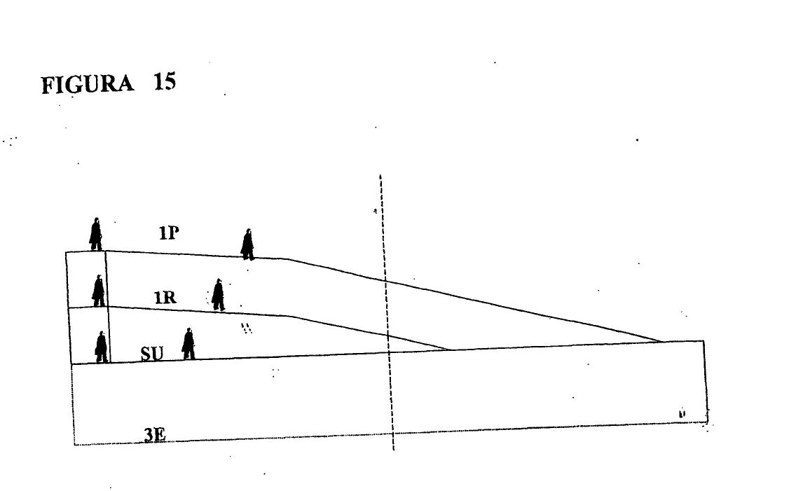

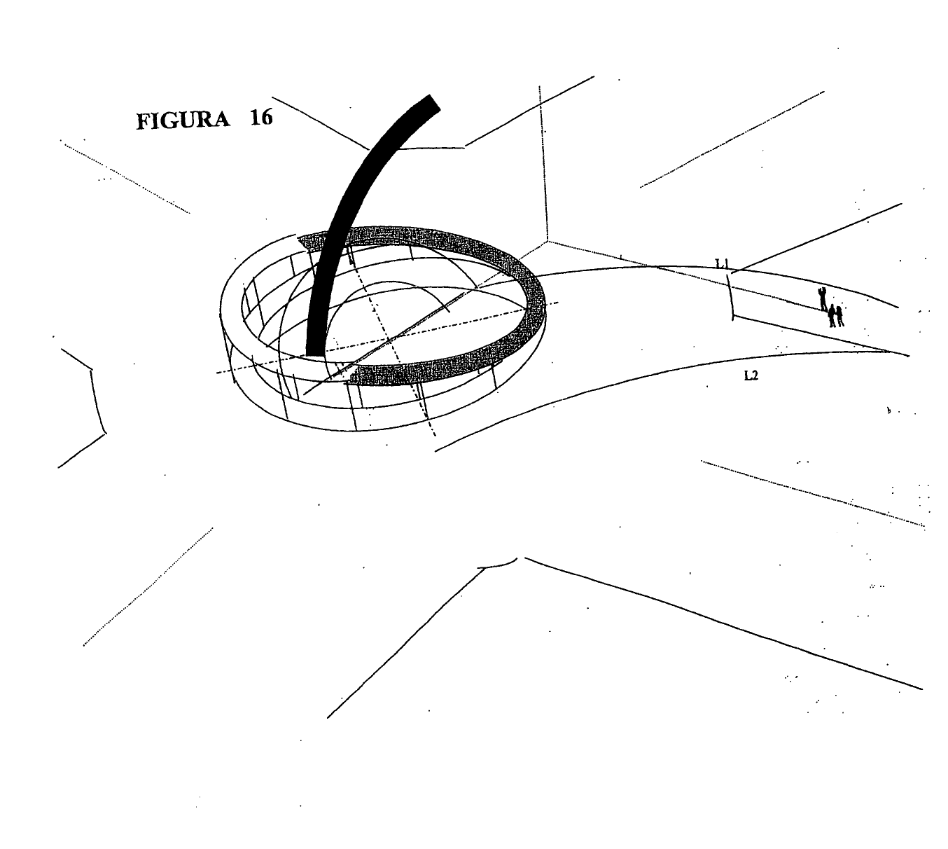

FIG. 6 represents how the sprayer out-put mouths have been placed on branch lines C1, C2, C3 and C4.

FIG. 13 shows the rainbows seen by observers in the exterior of the installation, placed at different positions inside the observation zone when the Sun is at 12° over the horizontal, the observation zone shall be between line L1 and line L2. The position of the observation zone shall vary with the change of position of the Sun and its width with the angle at which the Sun is to be found at each moment.

The sunrise and sunset zones of the Sun are approximately represented (grouped as “Summer” and “Winter” and capable of being more accurately grouped by months) for an installation that is at a latitude between 35-40°.

FIG. 14 shows the marks on the floor that shall be placed, for the zones outside the installation. Sunrise and the first hours of the day shall be marked (with Sun angles below 25-30°). The same is done for sunset, with which the sunrise and sunset zones are obtained; in this figure the sunrise has been marked at both Equinoxes and in the Summer and Winter Solstices.

Additionally, concentric circles shall be marked. These delimit the zone that is furthest from the installation from which the arc can be observed for a determined angle of the Sun over the horizontal (0°, 10°, 20°, 30°), considering that the observer is situated along the line that marks the hours at that moment.

These markings may vary when the height and position at which the arc-generator is situated varies, and can, in a certain measure, be adapted to each square.

P1 shall be the position at which the arc-generator must be placed at sunrise in the Winter solstice and P2 is the position for the equinox, in order to be able to observe the rainbow outside the installation. The radius of the pool is (R) in the figure.

FIG. 15 represents an installation of great radius on which an ascending observation ramp has been assembled (1R), intermediate between the floor (SU) and the main ascending observation ramp (1P), with which the shadow projected by the ramp over the water curtain is minimized. The pool in this figure corresponds to reference (3E).

FIG. 16 shows the observation of a large-sized rainbow from outside the installation due to the effect of the wind.

FIG. 17 represents the set of markings painted at the base of the pool in order to know at each moment, the situation of the Sun, the month of the year and the hour.

It is in simplified mode, and the necessary markings shall be placed depending on the level of the detail required to be reached, taking, of course, into account the radius of the pool (r) that will permit a greater or lesser detail.

The angles reached by the Sun at each month (or the estimated division) shall be marked on the observation ramp (as is seen in the drawing zoom), so that when comparing it with the angle measurer that is incorporated in the arc-generator, it offers the date or present time of year. 76° corresponds to the Summer solstice, 53° corresponds to the equinox, and 30° corresponds to the Winter solstice.

FIG. 18 shows the observer in a fixed elevated point O. The arc-generator must be moved to place it at each moment in the optimum situation (point P) depending on the position of the Sun. The observer would be situated at this elevated point and would only have to look towards the arc-generator in order to observe the rainbow at each moment. Height H is the height at which the observer must be placed and shall depend on the geographic latitude.

FIG. 19 presents a variant of the general case, in which the observation platform is removed; by means of a pool of sufficient depth (it shall depend on the geographic latitude), the observer shall be placed looking towards the arc-generator and around the perimeter of said enclosure. The arc-generator shall be situated in an appropriate position and height at each moment (point P) moved by a mechanical arm.

FIG. 20 represents a platform provided with a turn around an axis E1. With the turn around this axis and the displacement upwards or downwards, the observer on the platform also obtains the appropriate position at each moment. It can of course, be combined with a pool in order to reduce the height of the platform.

### PREFERRED EMBODIMENT OF THE INVENTION

An installation intended for a circular zone, that has an arc-generator perpendicular to the rays of the Sun and that shall generate a curtain of water drops and an observation platform on its perimeter is described in detail. The observation of the 180° of the upper part of a rainbow with similar radius to that of the installation is intended to be achieved at all moments with this installation.

In order to obtain an optimum observation position, the following rules must be met for any position of the Sun:

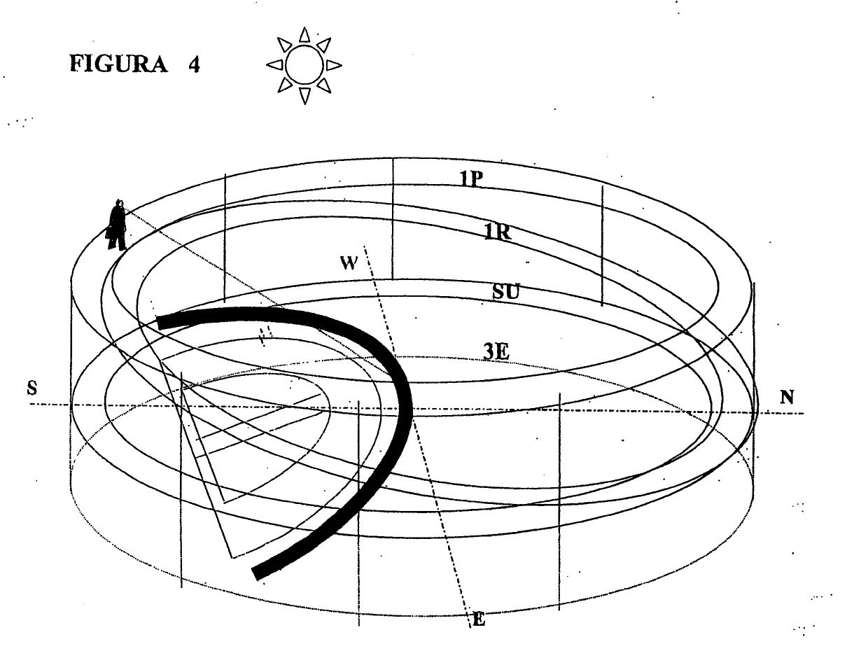

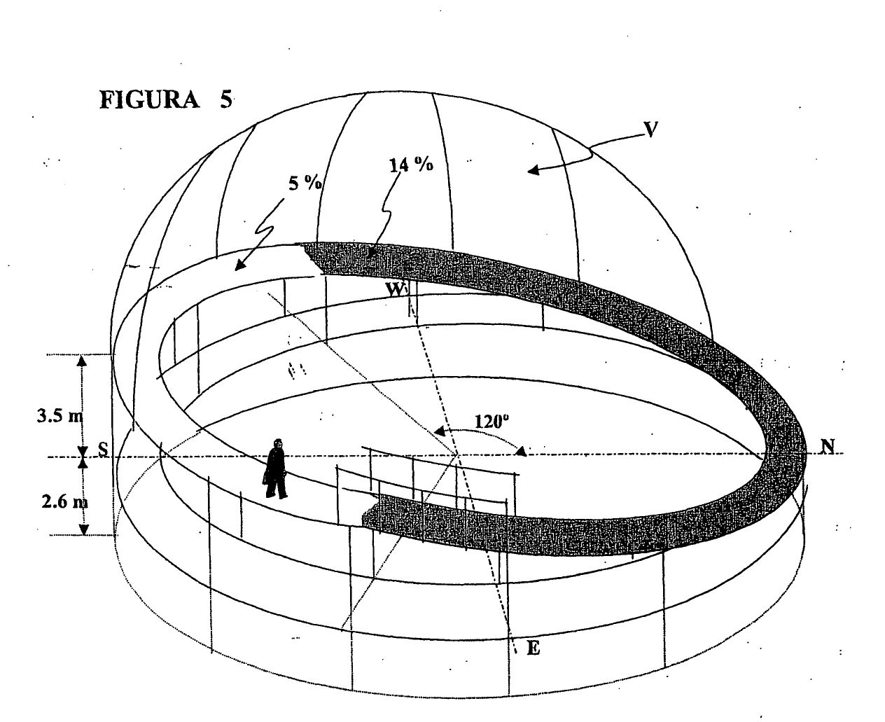

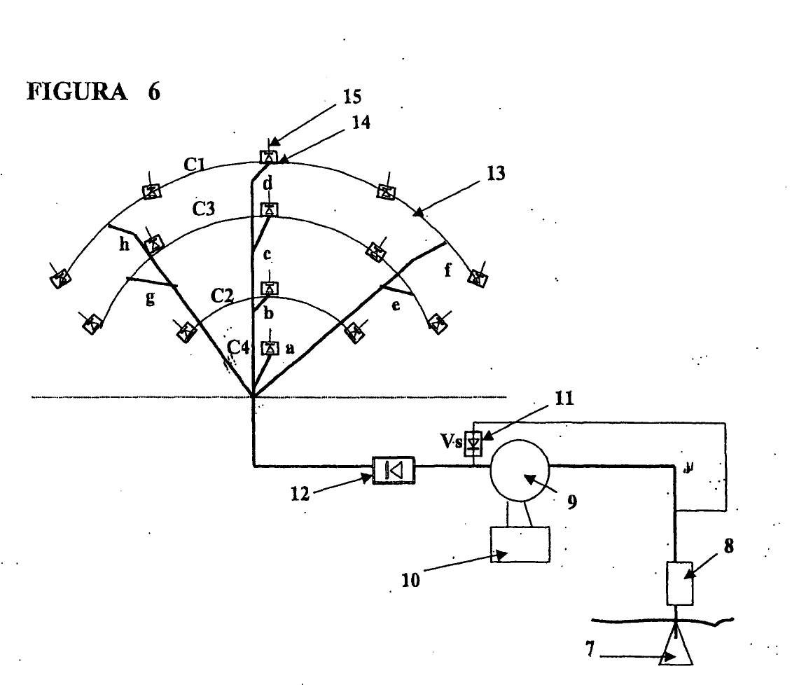

Observing FIG. 2, the arc-generator must always be situated on a perpendicular plane to the rays of the Sun.

The observer situated on the observation platform must be placed backwards to the Sun (point O) in front of the arc-generator and shall be perpendicular to the middle point of the arc-generator base (point P) . Angle POA shall be 42° 2′, angle POB shall be 40° as indicated in the drawing. The Sun, point O and point P shall be on one same perpendicular plane to the horizontal. The straight line OP is parallel to the rays of the Sun at all moments.

OA and OB rotate around their directrix, forming 2 observation cones in such a way that the rainbow shall be formed in all water curtains with the appropriate characteristics that intersect with these two observation cones. See FIGS. 2 and 12.

Distance OP=1,15*Ra (Ra being the radius of the observable rainbow). The rainbow width shall be 1,52*Ra*sen(2°′), this fringe being where the 7 colours are observed.

The shape a typical observation platform must have, shall be determined taking into account the previously indicated criteria as regards the optimum relative position.

An observation platform that is going to be used that shall be provided with an ascending observation ramp plus a pool with a determined depth, as the one in FIG. 2.

The ascending observation ramp is constructed of a ramp that spirally ascends going round an imaginary cylinder, perpendicular to the floor, that shall have as base, the circumference of the installation pool. In the Northern Hemisphere, this ramp starts in the North, ascending 180° from the floor until it reaches the South (its highest point) as from which it symmetrically descends until it reaches the floor once again; it shall therefore have two sides by which the ascending and descending is accomplished. In the Southern Hemisphere, the orientation of the ramp shall be the reverse.

The minimum depth of the pool plus-the height of the ramp reached at each point to make possible the observation of a rainbow with given dimensions at all moments, shall be determined by the geographic latitude.

Tables can be listed that, depending on the dimension of the rainbow to be observed and on the latitudes, will give the minimum height that must be reached by the observation platform at each point. In non tropical latitudes, the equation of the ecliptic on the day of the Summer solstice shall serve as reference to obtain these minimum heights.

The lesser the latitude, the higher the height reached by the Sun, so that the observer shall have to be placed at a greater vertical distance on the arc-generator base. To obtain this vertical distance, we play with two parameters, the height reached by the ramp plus the depth of the pool, both of them shall be the sum of the total vertical distance to be obtained.

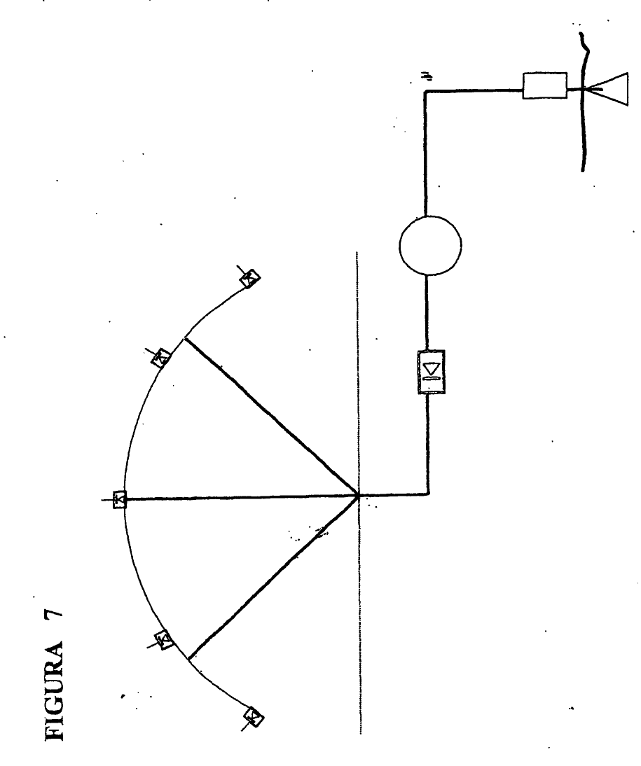

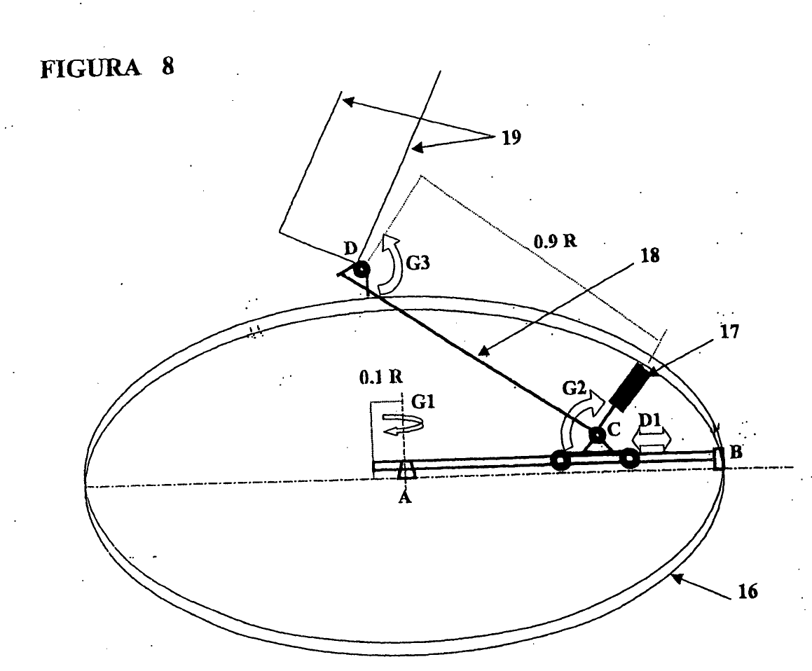

In high latitudes all the distance with the observation-ascension ramp of the observation platform can be obtained, FIG. 3.

In middle latitudes, the height is obtained with the sum of the observation-ascension ramp plus the depth of the pool.

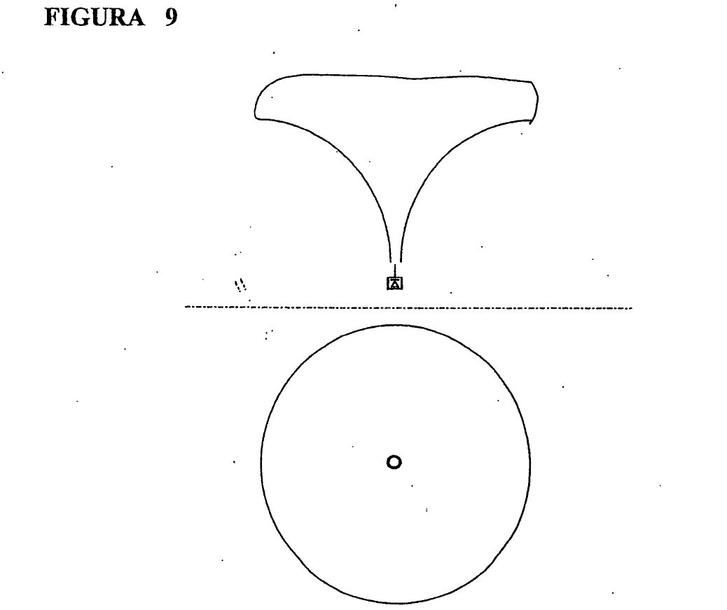

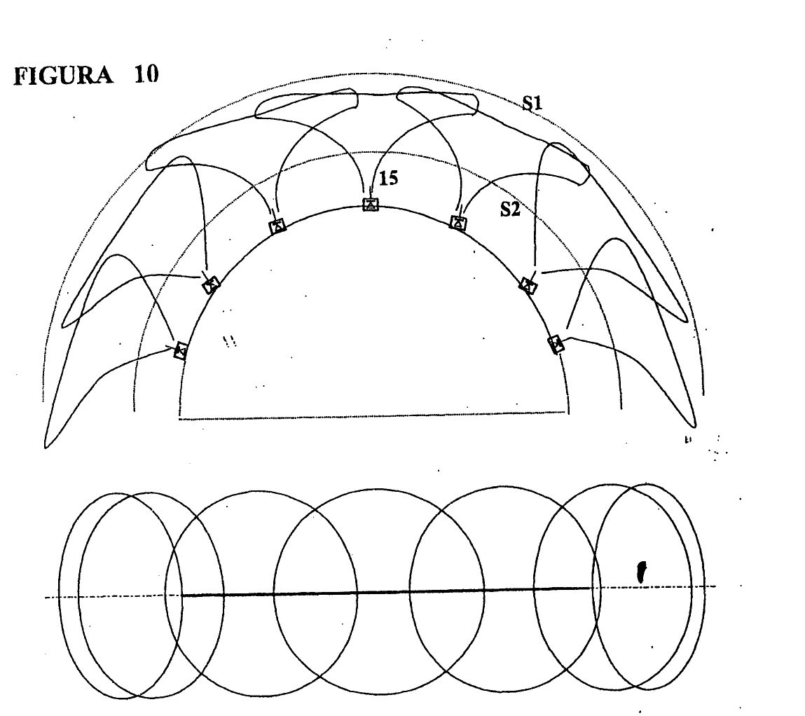

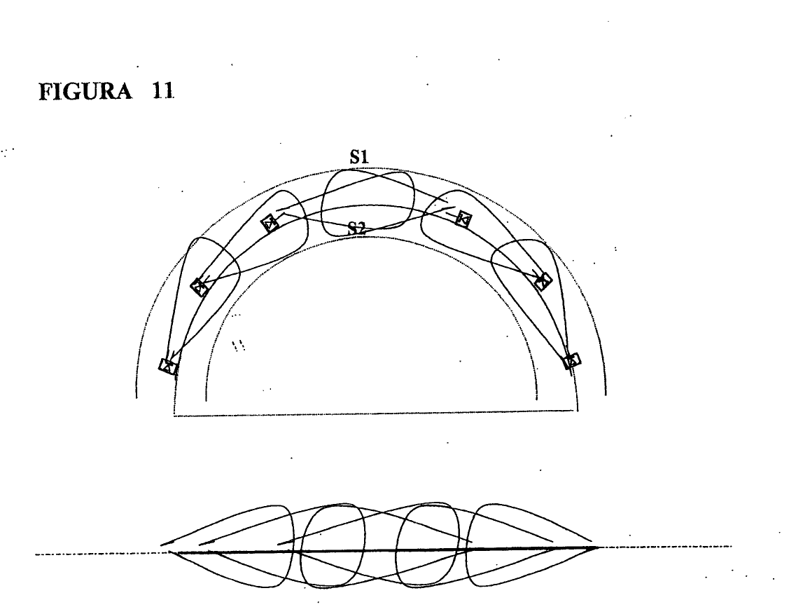

In equatorial latitudes an elevated observation platform shall be used (that is accessed by an observation-ascension ramp) equal at all points, plus the depth of the pool (FIG. 4).

The minimum height that must exist between each point of the observation platform where the observer is placed and the base of the arc-generator in order to observe at least 10° of the upper part of a rainbow with radius R^{a} in a non-tropical region shall be:
H=sen(S°)*1.15 *R^{a}−1.7
H—height at which the observation platform must be placed as regards the arc-generator base.
S°—angle of the Sun at each moment, as regards the horizontal on the day of the Summer solstice (shall depend on the latitude).
R^{a}—radius of the generated rainbow
1.7 m, which is the height of the eyes of the average observer, is subtracted.

A compromise must be reached between the height of the ramp and the depth of the pool. The lowest possible ramp is advisable, since it minimizes the splashing outside the installation due to spraying, which implies a deeper pool; however, with a pool that is too deep, the arc-generator will spend more time below the level of the ground throughout the day, which decreases its spectacularity.

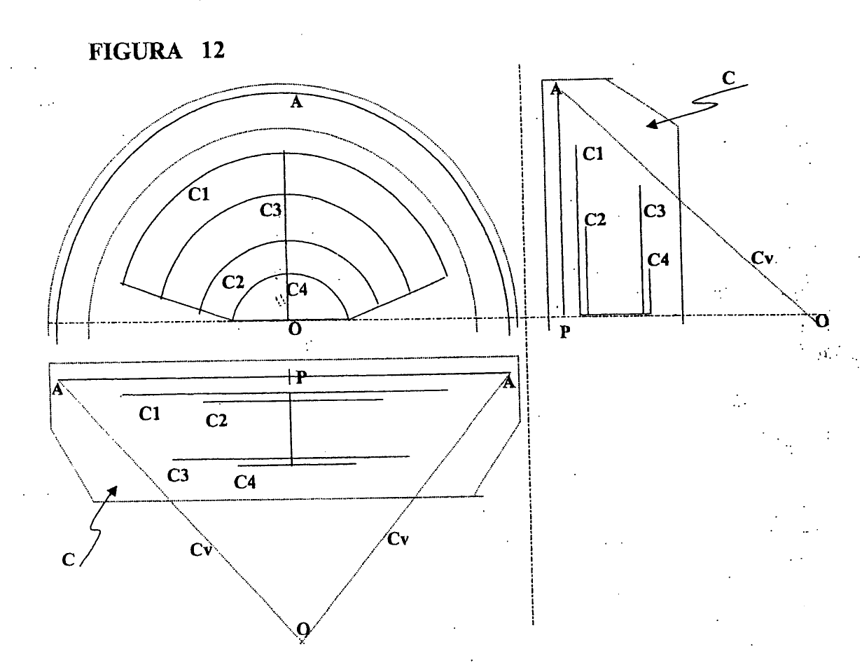

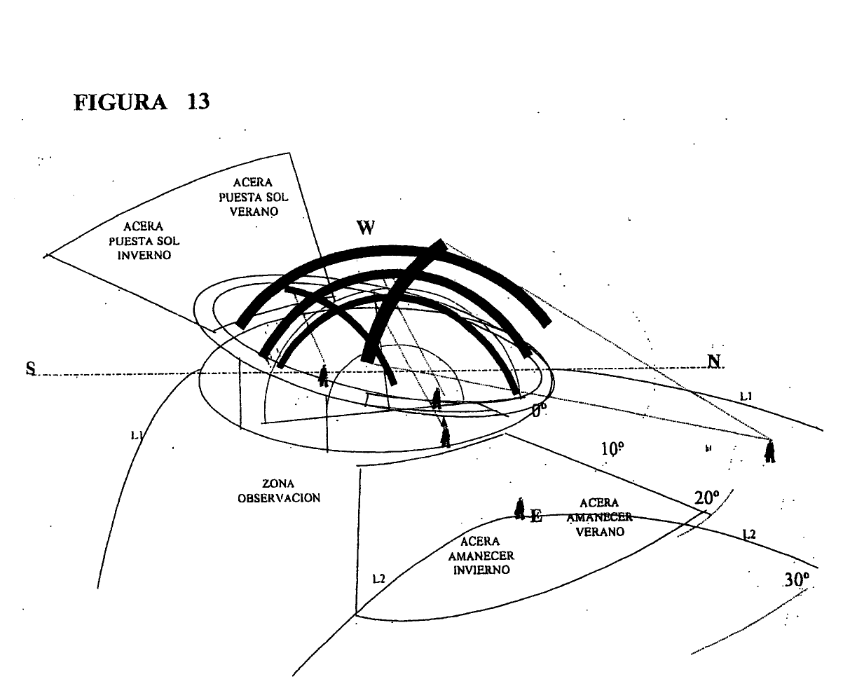

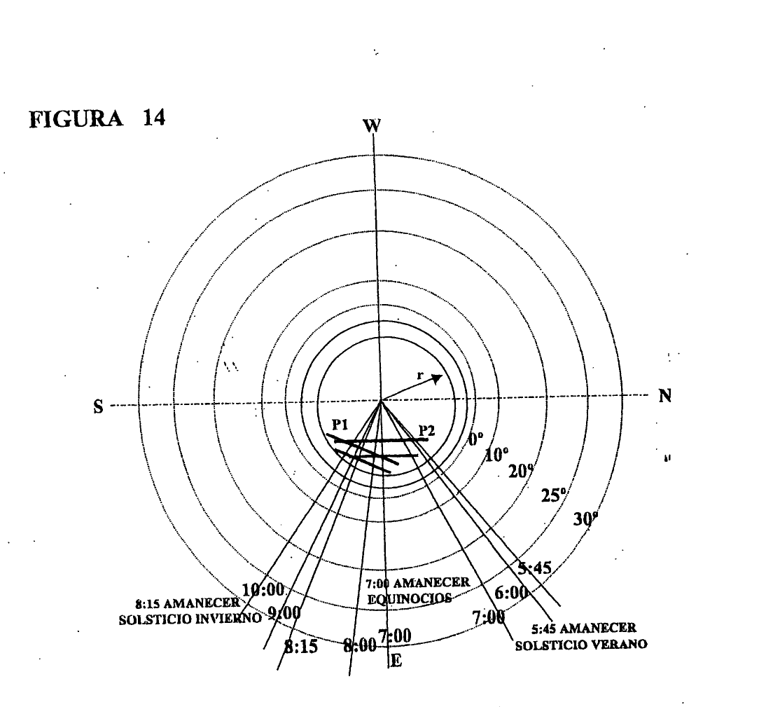

FIG. 5 represents a valid observation platform for installations placed between 35° and 40° Northern latitude.

The ascension-observation ramp has two slopes, one more pronounced at the beginning, of approximately 14% during the first 120° of ascension and one less pronounced of 5% during the remaining 60° of ascension. This double slope is used since the Sun describes a curve that is kept approximately during these 60° in high positions, subsequently dropping rapidly. With this double slope, the height to be obtained by the observation ramp is minimized. This formula with two or more different slopes, minimizes the maximum height to be reached by the platform at any latitude. The ascension-observation ramp shall be logically surrounded by a handrail on both sides.

A platform for latitudes between 35° and 40°. North, for a pool radius of 10 m with a generated rainbow with radius around 8 m and an arc-generator with 5 m radius, shall come to have approximately 3.5 m on the highest part of the ramp and a pool depth of 2.6 m. The ascension ramp shall be around the pool and shall have a width of approximately 1.5 m. In this platform represented in FIG. 4, arcs of 8 m radius can be observed when the Sun is at angles between 0° and 50°, when the Sun is at its highest point at angles between 50° and 76°, arcs between 8 m and 6.5 m radii shall be seen; the radius of the arc observed is slightly reduced in order to reduce the total height of the ramp-pool assembly.

A windshield (V) can be used to prevent the spilling of water drops outside the installation. The windshield can be constructed in the shape of a segment of a sphere or similar shape that partially surrounds the installation and that automatically rotates to confront the wind direction (FIG. 5), in this way, the position of the curtain of water drops is stabilized and the influence of the wind is minimized.

The dimensions and coverage of the windshield shall depend on the wind conditions in the installing zone. The shield can be totally or partially removed automatically the moment there is no wind or when it is not necessary due to the position of the curtain.

As regards the arc-generator, it is constructed as a hydraulic semi-circular shaped circuit, this circuit is going to have various branches, each one of which is provided with a plurality of sprayers uniformly distributed and orientated in ascending direction.

The system consists of a series of elements that are seen in FIG. 6, the supply is achieved through a water outlet (7), this water passes through a purifying filter (8) and reaches a hydraulic pump (9) equipped with rate meter (10), a safety valve (11) is placed at the outlet of the pump, tallied at a specific pressure to protect the installation from a possible burst of pressure, subsequently a one-way valve is installed (12) to protect the pump, when it reaches the arc-generator, the main conduit sub-divides into three branch lines that feed the semi-circular branches (13) at three different points with the purpose of verifying the distribution of the feeding; all the main conduit branch lines (a,b,c,d,e,f,g,h) shall have a section that is proportional to the total number of nozzles to be fed, to maintain the same pressure. At the mouth, just before each spraying nozzle (15) a choke is assembled (14) for a final adjustment of the out-put pressure, so as to maintain constant a determined pressure and to create, at all moments a uniform curtain of water drops, and with an appropriate concentration in the number of drops per volume. FIG. 12 shows the position adopted by the semi-circular branch lines Cl, C2, C3 and C4.

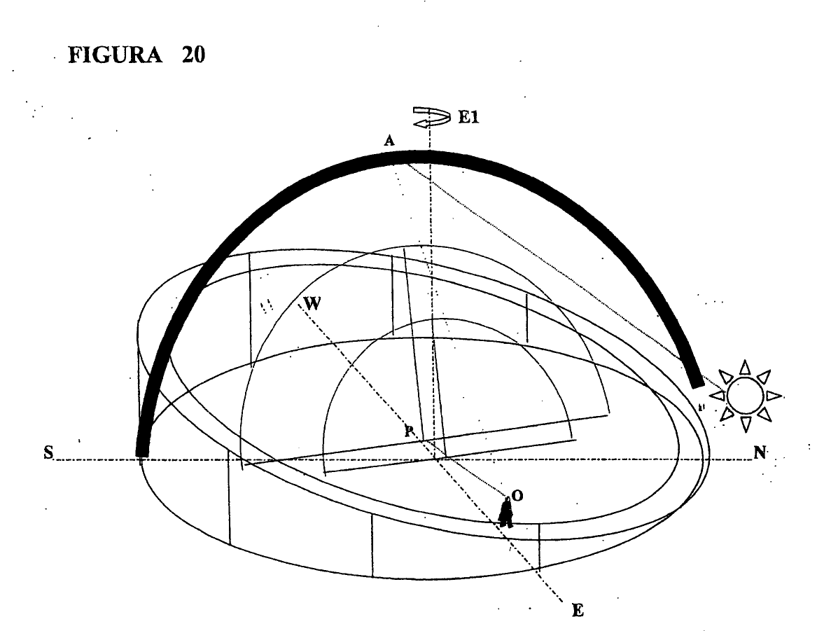

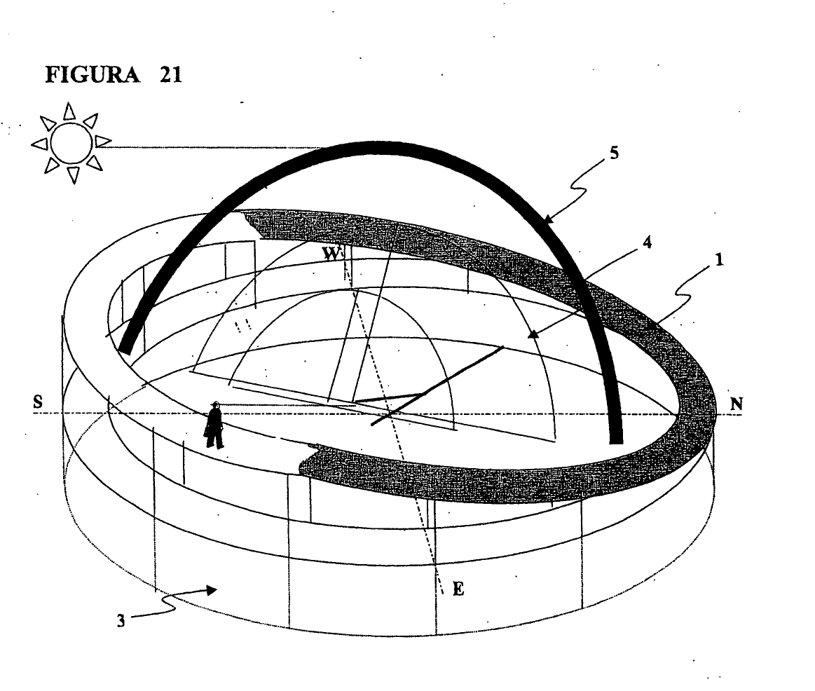

The hydraulic circuit is supported by a simple metallic structure that will move a mechanical arm to achieve a correct orientation at each moment (FIG. 8).

Consequently, the curtain of drops shall have an approximate semi frusto-conical shape, this geometry having been selected in order to optimise the necessary flow of water, minimize the water that is lost outside the installation as well as to adapt the apparatus to the geometry of the designed observation platforms. With this the creation of a curtain of water with similar radius to that of the installation, and that has a curtain width that shall be increased as the radius of the same increases is achieved. The curtain width must be around 50% of the arc radius produced.

The circuit is going to be fed by a hydraulic pump with rate meter to adjust the flow. When the flow varies in the jets that are produced by the spraying nozzles, the following occurs: if the flow increases, the pressure increases which implies that: the drops size decreases, the out-put rate of the drops increases, the height of the sprayer jet increases and its width decreases, if the flow decreases, the opposite effects are produced. Therefore, with the adjustment of the flow the sharpness of image of the phenomenon observed, can be adjusted.

It is advisable to use (as much as possible) both the pipes and the rest of the elements that are constructed with transparent materials (glass, plastic or similar material) thus gaining spectacularity and coverage of the arc-generator.

The installation is not going to be a closed circuit, since as a consequence of the sprayed water that comes out, there is going to be a supply to the same.

On the other hand, the optimum characteristics of the drops of the water curtain are as follows:

Using a given flow for the creation of the phenomenon, the rainbow is obtained with a greater intensity using small sized drops since a greater influence of the surface tension will exist in these drops, that will make them more spherical, which aids the production of the appropriate angles for the reflections and refractions at the same time obtaining a greater reflection surface for one same flow by using small drops, thus capturing a greater number of sun-rays, with the consequent existence of a greater number of reflected rays.

A greater concentration of drops will determine a greater reflection surface and in consequence a greater visualization of the phenomenon, so that much higher volumes of sprayed water per cubic meter to those of rain shall be used in order to achieve a greater intensity in the rainbow.

A greater uniformity in the distribution of the drops will contribute to a reflection uniformity which will make a maximum use of the reflection capacity of the flow and of the water curtain derived from it. In order to achieve this uniformity, the sprayers must be placed taking into account the geometry of their jets and the distance of these different flows.

The phenomenon is observed with greater sharpness of image if the rate of the drops is low. High service pressures will give us high drop rate results. On the contrary, small drops are a parameter that are inversly related to the drop size.

The greater the luminous environmental level, the greater shall be the intensity of the rainbow, and consequently the better the visualization, so that the ideal moments for the use of the installation shall be those near midday on sunny days.

In accordance with what has been previously indicated as regards the characteristics of the drops, it must be pointed out that air with high amount of moisture, near saturation (wet air) can be used as alternative to the use of a curtain of water drops; in this air, the rainbow is produced as occurs occasionally in nature.

The considerations described as regards situation, dimensions and geometry of the curtain are practically identical to those of a curtain of water drops.

For example, an arc-generator, similar as regards the geometry of the one described in FIG. 12 can be used to create a curtain of moisturized air with similar geometry. The air shall be forced through a humidifier to attain high humidity and will then exit through a plurality of air out-puts. In principle, more air out-puts will be necessary as well as an arc-generator with a greater radius to achieve a stable curtain of air in comparison with an arc-generator fed with water.

A mixed solution can be achieved using spraying nozzles that use pressurized air as spraying agent of the water. A mixture of small sized water drops and of saturated moisturized air will be obtained at the out-put mouths of these nozzles. These nozzles can be assembled in an arc-generator similar to that of FIG. 6 with the exception that the spraying nozzles must be fed with pressurized air that will require a pneumatic circuit in addition to the hydraulic circuit already present in the Figure.

Therefore we can choose from a wide range of spraying nozzles and out-put mouths. The use of spraying nozzles of the industrial type in existence in the Market are recommended, with which better production is obtained and which have their characteristics listed in a table, making it easier to comply with the necessary conditions of the previously indicated curtain.

Taking into account all the above, in addition to the radius of the installation, a series of tables must be reached empirically, that indicate the type of nozzles to be used depending on the radius of the installation, the quality of the curtain required and the factors to be considered, such as the allowable spraying outside the installation.

These tables include the nominal work pressures at which a better production of the spraying nozzles is obtained, from which the necessary flows and the dimensions of the generated jets shall be deduced.

The dimensions of the generated jets shall determine the number of branches that the arc-generator is going to have, and the number of sprayers per branch (See FIGS. 9 and 10)

In any case, in order to form the curtain of FIG. 12 (with an approximate semi frusto-conical shape, different solutions can be adopted: to place the spraying out-put mouths in radial direction and ascending direction as is seen in FIG. 10 to place them in circular direction and ascending direction as is seen in FIG. 11. In FIG. 10 sprayers have been used that provide a high quality curtain (small drops, etc.), in FIG. 11, sprayers have been used that provide more stable jets versus the action of the wind, since it generates larger drops and shorter jets, providing as a result, an inferior quality of curtain and therefore of less production.

Therefore, there is the possibility of using from moisturised air, passing through industrial sprayers, up to traditional fountain jets, provided they are placed in the indicated position, with which different qualities of curtains shall be obtained, one or another shall be chosen according to the needs and requirements of each zone.

When searching for an appropriate installing zone, two factors must be mainly considered: hours of direct incidence of the Sun (number of cloudless or partially cloudy days a year and their level of luminic intensity) and the possible interferences due to the height of buildings or constructions in the installation zone.

In low latitudes (between 35° North and 35° South), the Sun remains very high all day and rapidly rises and sets, the luminic intensity and the sunny days are many. In the Summer station, the Sun reaches heights over those in Winter, and having in addition, more hours of Sun, greater luminic intensity and more cloudless days. The type of climate or microclimate of the zone is also influencing. Arid climates with skies that are always cloudless and high luminic intensities are ideal.

Due to the evolution of the Sun's trajectory in one same square, the setting and rising zones together with the height reached by the Sun, change for the different stations.

A “shadow” in the installation zone may exist at certain times of the year and at certain hours of the day due to the interference of a building that would prevent the direct incidence of the rays of the Sun falling on the installation. Therefore, locations must be looked for in which this occurrence is minimised, that is to say, zones in which the surrounding buildings or constructions are not very high in relation to the total radius of the square or that are orientated in such a manner that they are free from buildings in the zones where the Sun rises and sets.

Wide pedestrian squares with gardens or similar spaces are very advisable since in them it is also possible to observe the rainbow outside the installation under the following conditions.

When the Sun is between 0° and approximately 25-30° (hours near sunrise and sunset when the Sun is low) the rainbow can be observed from outside the installation. The drawing of FIG. 14 reflects a typical square with total radius around 30-35 m, with a pool radius of 10 m and practically free from buildings in the zones in which the Sun is lowest.

For this the rainbow must be placed outside the relative optimum position that has been previously described. It shall be placed perpendicular to the floor and at a height over the ground from the base of the arc-generator of 1.5 m and always facing the rays of the Sun, it shall be placed approximately at 4 m (for a pool radius of 10 m) from the theoretical position of the observer in the platform at each moment, as is observed in FIG. 14.

In FIG. 13 we observe the part of the arc that would be seen by each one of the observers placed at different positions in the observation zone when the angle of the Sun is around 12°. For each angle at which the Sun is situated there is going to be an observation zone that will increase its dimensions as this angle increases, in the figure we observe the observation zone for an angle of 12°, each observer that is inside the zone shall see a rainbow that shall be the result of the intersection of its cones of observation with the generated curtain of water.

If the arc-generator is made to acquire a greater height, the observation zones shall be wider and the arc may be seen from further away from the installation, therefore this height can be adjusted according to the dimensions of the installation zone.

On the other hand, the hours when the Sun rises and sets each month shall be marked on the floor, obtaining what could be named as sunrise and sunset hours of the Sun. In FIG. 14 the sunrise hours for three days of the year have been marked as example: The Summer Solstice, the Winter Solstice and the Equinox.

In installations in which it is not possible to place the observer in these zones surrounding the installation (squares with cars around), the observer shall be placed in the perimeter of the pool but without climbing on the platform when the Sun is between 0° and 25-30°, the arc-generator shall be placed in its relative, theoretical, position as regards the observer, with which it is achieved that the arc-generator does not have to acquire an excessive height on the floor as happens if the observer is placed on the platform when the Sun is between these angles. With this type of installations situated for example in squares with road traffic, access must additionally be provided to persons by means of a subterranean, or elevated passage or zebra crossing.

There may even exist a ramp intercalated between the floor and the main one (in squares with large radii), see FIG. 15, in order to reduce the shadow of the main ramp on the curtain of water; when the Sun is between 0° and 25-30° in months with middle heights of the Sun such as Spring and Autumn, the observer shall be placed on the middle ramp and in Winter he shall be placed on the floor.

Once the angle has increased over approximately 25-30° in both cases, the rainbow may only be observed from the upper ramp of the installation.

Due to the incidence of the wind on the installation, on occasions a greater part of the arc may be observed from far-away zones than from the actual installation, as can be seen in FIG. 16.

On nights of full-moon and cloudless skies the “moon rainbow” can be observed by night, that is to say, due to the effect of solar rays on the lunar surface, the installation must be orientated towards the moon's reflection and the phenomenon shall be observed, though with less intensity than in daytime. The interference of artificial lights must be avoided as much as possible.

The mechanical arm can be managed by computer in such a way, that it is in the appropriate position at each moment, a solar-tracking sensor may help to carry out this task. The rate adjuster of the hydraulic circuit can also be acted on to increase or decrease the flow in the positions of interest.

In moments of slight illumination, very cloudy or with interference from the rays of the Sun due to buildings or other obstacles, the observation of the phenomenon will not be possible and the installation will automatically switch-off; as happens when there is much wind which would wet the surrounding zones. Then an anemometer to measure the rate of the wind and a sensor that will determine the level of luminosity at each instant shall be used.

Ideally, a central computer with specific software shall control all the previously indicated data in order to carry out an optimum management of the installation.

The installation may perform the functions of Sun dial, by drawing marks on the bottom of the pool with the position of the Sun at each hour of each month, the position of the base of the arc-generator will show the hour of the day at each instant (FIG. 17).

By drawing the compass-card on the base of the pool, the base of the arc-generator will give us the position of the Sun and by providing the arc-generator with a measurer of angles, we shall obtain the angle of the Sun as regards the horizontal at each moment.

By marking at each certain distance on the observation platform, the degrees as regards the horizontal at which the Sun is placed each month, and by comparing the indications of the angle measurer situated on the arc-generator with the marking on the platform for each month, we obtain the month, once the month is known, we see the hour marked by the base of the arc-generator for this month. A certain level of detail in the dates over that of the month can be reached.

With this series of marks the installation gives the date, the hour, the hours of sunrise and sunset, and in consequence the duration of the days and the position of the Sun at each moment.

By varying the absolute positions of the generator arc and/or the observation platform, different solutions can be obtained that may better adapt to different zones. Some of these are shown.

If the observer is kept fixed on an elevated point O, the arc-generator must be moved to place it at each moment in the optimum situation, depending on the position of the Sun. The observer would be situated in this elevated point and would only have to look towards the arc-generator to observe the rainbow at each moment. (FIG. 18). It is useful for placement in elevated zones, cliffs, towers, etc.

The observer shall be placed, by means of a pool with sufficient depth, looking towards the arc-generator and around the perimeter of said precinct. The arc-generator shall be placed in the appropriate position and height at each moment, moved by a mechanical arm (FIG. 19).

A platform provided with a turn around an axis E1 (FIG. 20) can be used. With the turn around this axis and the displacement upwards or downwards by the platform, the observer will also accomplish the obtention of the appropriate position at each moment. The arc-generator shall be placed in the appropriate position and height at each moment, moved by a mechanical arm. It can of course be combined with a pool to reduce the height of the platform.

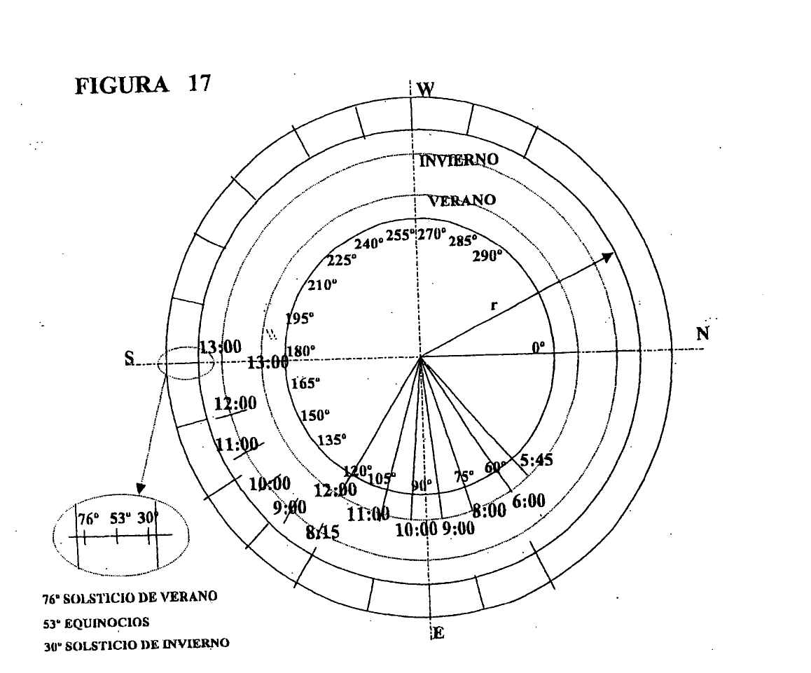

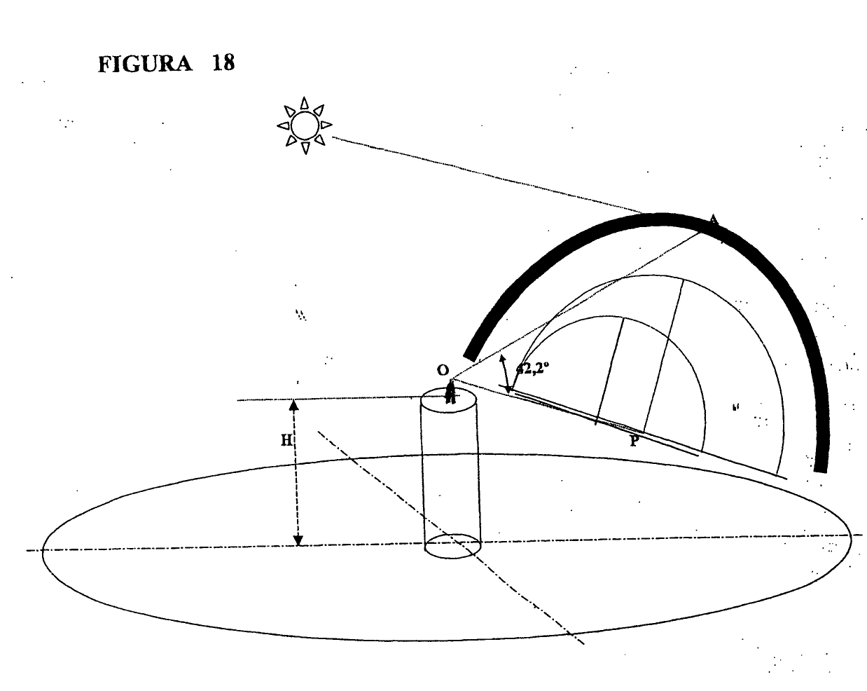

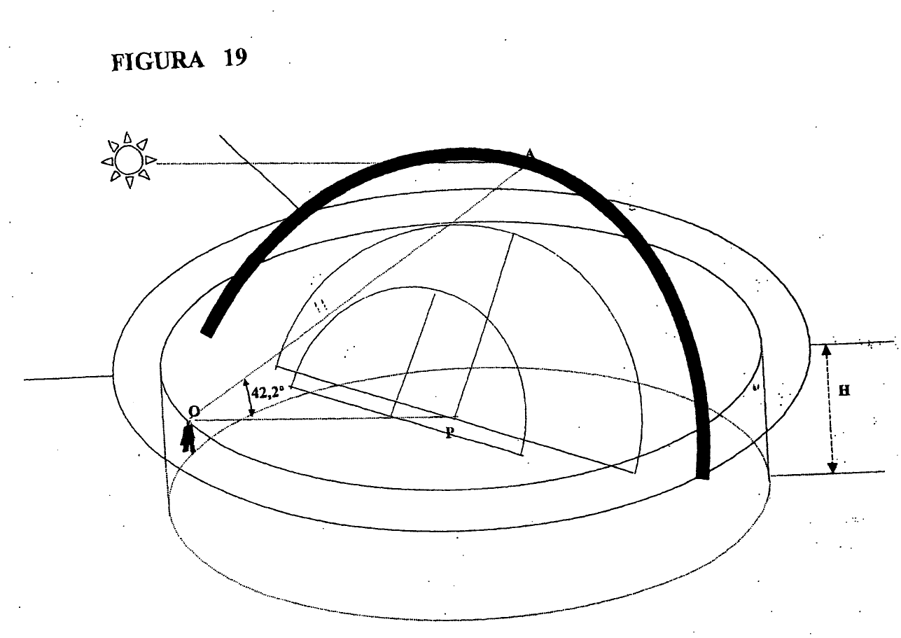

The installation will function with any radius, therefore simplified versions can be obtained to reduce costs and to perform a product such as “garden kit” for use in private homes. A simplified arc-generator (FIG. 7) that is complemented with a small ascension ramp, with a pool or with a combination of both shall be used depending on what applies in each case.

Drawings

FIG. 13
PAVEMENT
WINTER SUNSET
PAVEMENT
SUMMER SUNSET
OBSERVATION ZONE
PAVEMENT
WINTER SUNRISE
PAVEMENT SUMMER SUNRISE

FIG. 14:
8:15 SUNRISE
WINTER SOLSTICE
7:00 SUNRISE
EQUINOXES
5:45 SUNRISE
SUMMER SOLSTICE

FIG. 17
76° SUMMER SOLSTICE
53° EQUINOXES
30° WINTER SOLSTICE

1.- Installation for the generation and observation of the rainbow, which, having as objective, the visualisation of said rainbow at any time and date of the year, in any geographic zone and with independence from climatic conditions, is characterised because it is constituted by a curtain of water drops or alternately, by a curtain of moisturised air (C) with appropriate drop geometry, dimension, position and characteristics to produce the intended phenomenon in the drops of said curtain by the same causes that produce the natural phenomenon; having planned that the curtain of water drops or moisturised air are complemented with an observation platform (1) where the observer is placed, in order that the relative, appropriate positions between the observer and the curtain may be maintained at all moments for any position of the sun.

2.- Installation for the generation and observation of the rainbow, according to claim 1, characterised in that the observation platform (1) permits the placement of the observer at a minimum necessary distance at all moments as regards the curtain of water drops or moisturised air (C), depending on this minimum distance of the angle of the Sun on the horizontal and on the dimensions of the rainbow (5) that is wished to be observed; the observer being placed on the platform backwards to the Sun and looking towards the curtain whilst the curtain is totally or partially placed in the space comprised between two imaginary revolution cones that have their vertex on the observer, their generatrix at approximate angles of 40° and 42° respectively and that possess their common and parallel axis to the rays of the Sun at all moments, in such a manner that the observer-curtain backwall distance where the rainbow is observed shall determine the radius (r) of the rainbow that is observed, with the particularity that the curtain must be made up of drops with reduced volume, uniformly distributed and with a high concentration of drops or by saturated moisturised air.

3.- Installation for the generation and observation of the rainbow, according to claim 2, intended to be installed in a circular zone, characterised in that the observer is placed on an observation platform (1) situated on the perimeter of the zone; the platform having a minimum sufficient height at each point in order to observe the rainbow (5) with desired dimensions at all moments; the observer being placed backwards to the Sun and looking towards the curtain; said curtain shall be inside the perimeter of the installation; so that the dimensions and position of this curtain are determined by the angle of the Sun at each moment and the dimensions of the rainbow (5) that is wished to be observed; the geometry of the curtain of water drops or moisturised air (C) being capable of adopting diverse shapes with which similar results can be obtained.

4.- Installation for the generation and observation of the rainbow, according to claim 1, intended to be installed in a circular zone, characterised in that the observation platform (1) is constructed as a combination of an elevated platform at a determined height (H) at each point of the perimeter of the circular zone plus a circular pool (3) coinciding with the zone in which it is going to be installed and with a determined depth. In turn the observation platform can be constituted only by the elevated platform or by the circular pool.

5.-Installation for the generation and observation of the rainbow according to claim 4, characterised in that the observation platform (1) consists of an elevated platform that is constructed as an ascending observation ramp that surrounds the installation and of a circular pool (3); in such a manner, that the depth of the pool plus the minimum height of the ramp shall be reached at each point in order to be able to observe a rainbow (5) with given dimensions at all moments, shall depend on the geographic latitude; being capable of using, especially for high latitudes, observation platforms that only have the ascension ramp or that only have the pool; having planned that in installations with large radii and in tropical latitudes, intermediate ascension observation ramps can be added (1R) intercalated between the floor (SU) and the main one (1P); in windy zones, windshields (V) can be used in order to prevent spraying outside the installation.

6.- Installation for the generation and observation of the rainbow, according to claim 1, characterised in that a curtain of water drops (C) is used that is placed at all moments perpendicular to the rays of the Sun.

7.- Installation for the generation and observation of the rainbow according to claim 6, characterised in that the curtain of water drops (C) is generated by an apparatus that is kept perpendicular to the Sun at all moments, moved by a mechanical system and that, by means of a plurality of spraying out-put mouths (15) distributed in said apparatus, it generates a curtain of drops with reduced volume, distributed uniformly and with a high concentration of drops.

8.- Installation for the generation and observation of the rainbow, according to claim 7, characterised in that the apparatus generator of the curtain of drops of water (C) is formed by a plurality of semi-circumferential conduits (13) perpendicular to the Sun at all moments, in which uniformly distributed water out-put mouths (15) are established, that carry out the spraying orientated in ascending direction, in such a way that they create a curtain of water with an approximately semi frusto-conical shape; the curtain having dimensions that shall depend on the radius of the rainbow that is wished to be observed; whilst the optimum situation of the observer shall be on the observation platform, backwards to the Sun and facing the curtain of water drops in the “semi frustum of cone” axis, that forms the curtain of water drops at a distance from the curtain backwall that shall depend on the radius of the arc that is wished to be observed.

9.- Installation for the generation and observation of the rainbow, according to claim 8, characterised in that it possesses a hydraulic circuit with flow adjustment means (10) capable of feeding the system and of maintaining a constant pressure in the spraying out-let mouths; managing automatically, the opening or locking of the feeding of fluid, depending on the atmospheric conditions; the sprayers (15) being of the industrial type to obtain a better quality in the required characteristics of the curtain of water drops; whilst the materials shall be transparent as much as possible in the different elements that make up the curtain generator apparatus in order to increase the spectacularity.

10.- Installation for the generation and observation of the rainbow, according to claim 7, characterised in that the mechanical system that moves the water curtain generator apparatus in order to place it in its optimum position at each moment is constructed in the case of a circular installation, as a mechanical arm provided with three turning axes and a radial displacement.

11.- Installation for the generation and observation of the rainbow, according to claim 1, characterised in that the rainbow is observed from the outside of the observation platform (1), the curtain of water drops or curtain of moisturised air, being at all moments situated perpendicular to the floor and facing the Sun; the optimum situation of the observer on the observation platform being with his back to the Sun facing the curtain, depending on the dimensions and situation of the zone in which the observer can see the rainbow, in addition to the optimum position of the observer inside this zone, on the dimensions of the curtain and on the angle of the Sun.

12.- Installation for the generation and observation of the rainbow, according to claim 1, characterised in that it can be used as sun dial and calendar; in such a way that the apparatus that creates the curtain shall serve as reference for marking the position of the Sun at each moment and with the help of markings on the observation platform and inside and outside the installation, it is possible to see the approximate time and date, as well as the sunrise and sunset time and the duration of the day.

13.- Installation for the generation and observation of the rainbow according to claim 1, characterised in that the observer is kept fixed in an elevated point, at a sufficient minimum height for the observation of the rainbow at all moments with desired dimensions, the curtain of water or moisturised air being placed at each moment in the optimum situation, depending on the position of the Sun and on the dimensions of the arc that is wished to be observed; in such a manner, that the observer situated at this high point shall only have to turn around and look towards the curtain in order to observe the rainbow at each moment.

14.- Installation for the generation and observation of the rainbow according to claim 1 and 3, characterised in that the observation platform is mobile and shall have an axis perpendicular to the horizontal plane, situated on the centre of the installation around which the observation platform can rotate; in such a manner that using the turn around this axis and the movement of the observer on the platform, the observer can be situated in the required position at each moment
